(19) United States
(12) Patent Application Publication
(10) Pub. No.: US 2002/0161165 A1
(43) Pub. Date: Oct. 31, 2002

(54) Core guest host systems

(76) Inventors: Rebecca Ellen Taylor, San Carlos, CA (US); Susan Patricia Ermer, Redwood City, CA (US); Peter V. Bedworth, Palo Alto, CA (US); Steven M. Lovejoy, Sunnyvale, CA (US); Doris S. Leung, Los Altos, CA (US); Hope B. Warren, Newberg, OR (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/119,316

(22) Filed: Apr. 10, 2002

Related U.S. Application Data
(60) Provisional application No. 60/282,478, filed on Apr. 10, 2001.

(51) Int. Cl. C08G 64/00

(52) U.S. Cl. 528/196

(57) ABSTRACT

A chromophore in a polymer is given having the structure

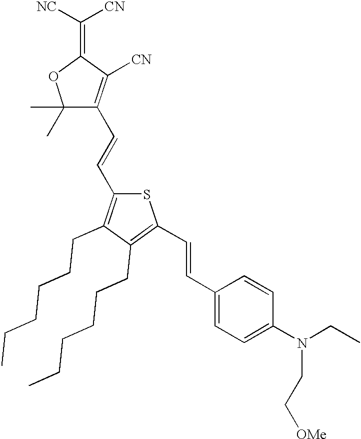

in a polycarbonate matrix.

This application is based on Provisional Application No. 60/282,478 filed April 10. 2001.

### FIELD OF THE INVENTION

The present invention relates to novel organic chromophores with matrix materials and methods of making and using the same.

### BACKGROUND OF THE INVENTION

Known materials for use in electro-optic devices include both organic and inorganic materials. Semiconductor materials such as gallium arsenide, organic crystalline materials and organic materials prepared by sequential synthesis methods are used as well as electrically poled polymer films containing organic chromophores incorporated either physically to form composites or chemically to form homopolymer materials. See Kirk-Othmer Encyclopedia of Chemical Technology, 4^{th} Edition, Volume 17 (John Wiley & Sons, New York, 1995) pp. 288-302.

When an electric field is applied to electro-optic materials, the highly polarizable electrons in those materials change significantly resulting in an increase in the index of refraction of the materials and a decrease in the speed of light passing through the materials. The change in the index of refraction can be used to impose electric signals onto optical signals to switch optical signals in a network or to control a beam of light.

The most commonly used inorganic material is lithium niobate which possesses an electro-optic coefficient on the of 35 pm/V which results in a typical drive voltage of about 5 volts. Because lithium niobate has a high dielectric constant which results in velocity mismatch of electric and optical waves propagating in the material, a short interaction length and limiting bandwidth results. In one analysis a one centimeter electro-optic modulator constructed from lithium niobate typically has a bandwidth of less the 10 Gigahertz.

In using organic materials systems, one obstacle to overcome is the decay of the poled electro-optic response at the elevated manufacturing and operating temperatures dictated by current electronic technology.

For generally useful devices, higher temperature electro-optic thermal stability is required. In some manufacturing processes, short-term temperature excursions can be high than 300 degrees C. In fabrication, the poling and curing temperatures of an electro-optic polymer for integrated devices may often exceed this limit.

### SUMMARY OF THE INVENTION

Accordingly, it is an object of the present invention to provide an electro-optic material that does not suffer from the limitations of prior materials used in the art.

It is a further object to provide a new class of highly hyperpolarizability organic chromophores.

It is yet a further object of this invention to show a process for synthesizing the novel highly hyperpolarizable organic chromphores.

Another object is to provide devices such as electro-optical modulators employing the new class of novel highly hyperpolarizable organic chromphores.

These and other objects of the present invention will become clear from the detailed description of the invention and the claims included below.

### DETAILED DESCRIPTION OF THE INVENTION

It is the purpose of this invention to make a nonlinear optical material in a polymer host. The functional material is a nonlinear optical material. It is made up of a polymer and a nonlinear optical dye or chromophore.

Nonlinear optical chromophores or dyes are constructed from three segments which include a donor material, a pi-conjugated bridge, and an acceptor. The donor is electron rich when compared to the acceptor and the bridge allows communication between the donor and the acceptor. To optimize the molecular hyperpolarizability or beta, one must strike a balance between the electron donating of the donor side and the electron accepting ability of the acceptor side such that the hyperpolarizability is optimized.

The current state of art chromophores have not been optimized for beta. The present invention chemically modifies a well studied acceptor to give rise to a more potent acceptor that does optimize the beta values in these chromophores. It does, however, not increase the ground state dipole or mu as expected. In addition it optimizing the beta values.

The following describes the chromophore or dye of this invention:

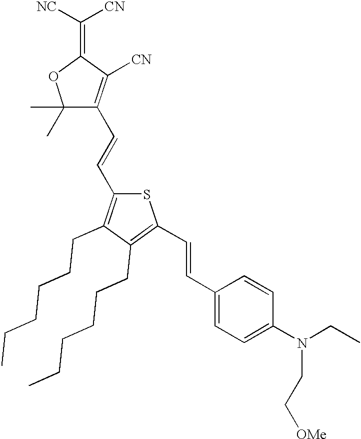

The following is the aldehyde may be used in this invention.

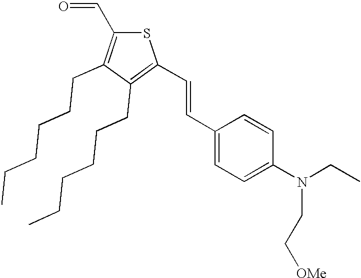

The following is the acceptor which can be employed in this invention.

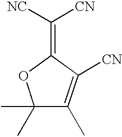

The reaction here is the Knovenegal condensation and is accomplished by putting the reactants together in solvents. While catalysts may be used, the preferred catalyst is pyridiunium acetate in ethanol.

The chromophore of this invention is 2-(3-Cyano-4-{2-[5-(2-{4-[ethyl-(2-methoxy-ethyl)-amino]-phenyl}-vinyl)-3,4-dihexyl-thiophen-2-yl]-vinyl}-5,5-dimethyl-5H-furan-2-ylidene)-malononitrile This is made from 5-(2-{4-[Ethyl-(2-methoxy-ethyl)-amino]-phenyl}-vinyl)-3,4-dihexyl-thiophene-2-carbaldehydewhich is reacted with 2-(3-Cyano-4,5,5-trimethyl-5H-furan-2-ylidene)-malononitrile.

The acceptor and the doner materials are conventionally made and reparation of such compounds is well known to those of ordinary skill in the art.

By following the above, the chromophore of this invention can be poled at lower field and has increased temporal stability. Temporal stability occurs when the nonlinear optical properties are maintained over time. This is a result of a reduction in electrostatic interaction between dye molecules.

The chromophore of this invention shows improvement over the previous dyes because of the presence of the groups on the acceptor portion of the molecule. This was a surprise because inductively withdrawing substituents on an acceptor was not expected to increase acceptor strength.

Useful products from the materials this invention maybe composed of polymers, such as, for example polyquinolines, polycarbonates, polyesters, polyurethanes, and other similar materials. The polymers should have a glass transition temperature or Tg which is sufficiently high so that the chromophore will be locked into place after poling but not so high that the chromophore decomposes. The polymer should be transparent at the useful wavelength. A particularly useful polymer is amorphous polycarbonate.

To make the matrix, the chromophore dye is disolved in a conventional solvent and the polycarbonate polymer is also disolved. The dye and polymer material are then spin cast, cured and poled.

While the preferred embodiments of the present invention have been described above, it should be understood that they have been presented by way of example only, and not of limitation. It will be apparent to persons skilled in the relevant art that various changes in form and detail can be made herein without departing from the spirit and scope of this invention. Thus the present invention should not be limited by the above described exemplary embodiments.

What is claimed is:

1. A chromophore having the structure 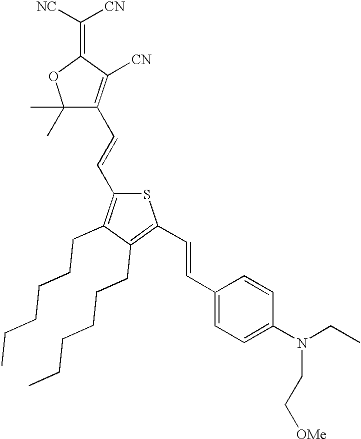
in a polycarbonate polymer.
